(19) United States
(12) Patent Application Publication
(10) Pub. No.: US 2024/0186568 A1
(43) Pub. Date: Jun. 6, 2024

(54) SO2-BASED ELECTROLYTE FOR A RECHARGEABLE BATTERY CELL AND RECHARGEABLE BATTERY CELL

(71) Applicant: Innolith Technology AG, Basel (CH)

(72) Inventors: Laurent Zinck, Mothern (FR); Christian Pszolla, Bad Schonborn (DE); Rebecca Busch, Bruchsal (DE)

(21) Appl. No.: 18/361,513

(22) Filed: Jul. 28, 2023

Related U.S. Application Data
(63) Continuation of application No. PCT/EP2022/051757, filed on Jan. 26, 2022.

(30) Foreign Application Priority Data
Jan. 29, 2021 (EP) 21 154 308.7

(51) Int. Cl. H01M 10/0562; H01M 4/02; H01M 4/131; H01M 4/134; H01M 4/38; H01M 4/583; H01M 4/62; H01M 10/0525

(52) U.S. Cl. CPC H01M 10/0562; H01M 4/131; H01M 4/134; H01M 4/382; H01M 4/583; H01M 4/623; H01M 10/0525; H01M 2004/027; H01M 2300/0071

(57) ABSTRACT

SO₂-based electrolyte and rechargeable battery cell (2, 20, 40) comprising this electrolyte, which electrolyte contains at least a first conducting salt of the following formula (I)

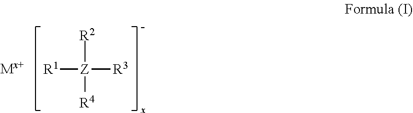

wherein M is a metal selected from the group formed of alkali metals, earth alkali metals, metals from Group 12 and aluminum; x is an integer from 1 to 3; R¹, R², R³and R⁴ are selected, independently of one another, from the group formed of a halogen atom, a hydroxyl group, an —OR⁵chemical group and a chelating ligand, which is collectively formed by at least two of the substituents R¹, R², R³and R⁴ and is coordinated to Z; wherein R¹, R², R³and R⁴ are neither four halogen atoms nor four —OR⁵chemical groups, in particular alkoxy groups; wherein the substituent R⁵ is selected from the group formed by C₁-C₁₀ alkyl, C₂-C₁₀ alkenyl, C₂-C₁₀ alkenyl, C₃-C₁₀ cycloalkyl, C₆-C₁₄ aryl and C₅-C₁₄ heteroaryl; and wherein Z is aluminum or boron.

### RELATED APPLICATIONS

This application is a continuation of PCT/EP2022/051757, filed Jan. 26, 2022, which claims priority to EP 21 154 308.7, filed Jan. 29, 2021, the entire disclosures of both of which are hereby incorporated herein by reference.

### BACKGROUND AND SUMMARY

This disclosure relates to an SO₂-based electrolyte for a rechargeable battery cell and to a rechargeable battery cell.

Rechargeable battery cells are of considerable importance in several technical fields. They are often used for applications when only small rechargeable battery cells having a relatively low current strength are required, such as when operating mobile phones. In addition, however, there is also a real need for larger rechargeable battery cells for high-energy applications, in which the mass storage of energy in the form of battery cells is especially important for electrically driving vehicles.

One essential requirement of such rechargeable battery cells is high energy density. This means that the rechargeable battery cell is to contain as much electrical energy as possible per unit of weight and volume. Lithium has proven especially advantageous as the active metal for this purpose. An active metal of a rechargeable battery cell refers to the metal whose ions migrate inside the electrolyte to the negative or positive electrode when the cell is charged or discharged, where they participate in electrochemical processes. These electrochemical processes lead, either directly or indirectly, to electrons being donated to the external circuit or to electrons being accepted from the external circuit.

Rechargeable battery cells containing lithium as the active metal are also referred to as lithium-ion cells. The energy density of these lithium-ion cells can be increased by increasing the specific capacitance of the electrodes or by increasing the cell voltage.

Both the positive and the negative electrode of lithium-ion cells are formed as insertion electrodes. Within the context of this disclosure, the term “insertion electrode” is understood to mean electrodes that have a crystalline structure in or from which ions of the active material can be inserted or removed during operation of the lithium-ion cell. This means that the electrode processes can take place not only at the surface of the electrode, but also inside the crystalline structure. Both electrodes generally have a thickness of less than 100 μm and are therefore very thin. When charging the lithium-ion cell, the ions of the active metal are removed from the positive electrode and inserted in the negative electrode. When discharging the lithium-ion cell, the process is reversed. The electrolyte is also an important functional element of any rechargeable battery cell. It usually contains a solvent or solvent mixture and at least one conducting salt. Solid electrolytes or ionic liquids do not contain a solvent, for example, only a conducting salt. The electrolyte is in contact with the positive and the negative electrode of the battery cell. At least one ion of the conducting salt (anion or cation) can move in the electrolyte such that charge can be transferred between the electrodes, this being essential for the rechargeable battery cell to function, by means of ionic conduction. The electrolyte is oxidatively electrochemically decomposed above a specific upper cell voltage of the rechargeable battery cell. This process often leads to components of the electrolyte being irreversibly decomposed and therefore to the rechargeable battery cell failing. Reductive processes can also decompose the electrolyte below a specific lower cell voltage. In order to prevent these processes, the positive and the negative electrode are chosen such that the cell voltage lies below or above the voltage at which the electrolyte is decomposed. The electrolyte thus defines the voltage window, within the range of which a rechargeable battery cell can reversibly operate, i.e., can be repeatedly charged and discharged.

The lithium-ion cells known in the art contain an electrolyte, which consists of a in an organic solvent or solvent mixture and a conducting salt dissolved therein. The conducting salt is a lithium salt, such as lithium hexafluorophosphate (LiPF₆). The solvent mixture can contain ethylene carbonate (EC), for example. The electrolyte LP57, which comprises the composition 1 M LiPF₆ in EC:EMC 3:7, is an example of such an electrolyte. On account of the organic solvent or solvent mixture, such lithium-ion cells are also referred to as organic lithium-ion cells. In addition to the lithium hexafluorophosphate (LiPF₆) often used in the art as a conducting salt, other conducting salts are also described for organic lithium-ion cells. For example, JP 4 306858 B2 (hereinafter referred to as [V1]) thus describes conducting salts, which are tetraalkoxyborate or tetraaryloxyborate salts, that can be fluorinated or partially fluorinated. JP 2001 143750 A (hereinafter referred to as [V2]) discloses fluorinated or partially fluorinated tetraalkoxyborate salts and tetraalkoxyaluminate salts as the conducting salts. In these documents, [V1] and [V2], the conducting salts described are dissolved in organic solvents or solvent mixtures and used in organic lithium-ion cells. The negative electrode of several organic lithium-ion cells consists of a carbon coating applied to a copper discharge element. The discharge element produces the required electronically conductive connection between the carbon coating and the external circuit. The positive electrode consists of lithium cobalt oxide (LiCoO₂), which is applied to an aluminum discharge element.

It has long been known that undesirable overcharging of organic lithium-ion cells leads to electrolyte components being irreversibly decomposed. In this case, the organic solvent and/or the conducting salt oxidatively decomposes at the surface of the positive electrode. The reaction heat formed during this destruction and the resultant gaseous products are responsible for the subsequent “thermal runaway” and the resultant destruction of the organic lithium-ion cell. The vast majority of charging protocols for these organic lithium-ion cells use the cell voltage as an indication that charging has finished. In this case, accidents as a result of the thermal runaway are especially likely to occur when using multicell battery packs, in which a plurality of organic lithium-ion cells having mismatching capacities are connected in series.

Therefore, organic lithium-ion cells are problematic in terms of their stability and long-term operational reliability. Risks to safety are in particular also caused by the combustibility of the organic solvent or solvent mixture. If an organic lithium-ion cell starts a fire or even explodes, the organic solvent of the electrolyte forms a combustible material. Another disadvantage of organic lithium-ion cells consists in that any hydrolysis products produced in the presence of residual amounts of water are very aggressive with respect to the cell components of the rechargeable battery cell. The above-described problems regarding the stability and long-term operational reliability are particularly grave when developing organic lithium-ion cells, which, on the one hand, have very good electrical energy and performance data and, on the other hand, have very high operational reliability and service life, in particular a high number of available charge and discharge cycles.

One development known in the art thus provides the use of an electrolyte based on sulfur dioxide (SO₂) for rechargeable battery cells instead of an organic electrolyte. Rechargeable battery cells containing an SO₂-based electrolyte comprise, inter alia, high ionic conductivity. The term “SO₂-based electrolyte” is understood to mean an electrolyte that not only contains SO₂ as an additive in a small concentration, but also in which the mobility of the ions of the conducting salt, which salt is contained in the electrolyte and brings about the transfer of charge, is, at least in part, largely or even fully ensured by SO₂. The SO₂ is therefore used as a solvent for the conducting salt. The conducting salt can form a liquid solvate complex together with the gaseous SO₂, wherein the SO₂ is bound and the vapor pressure is markedly reduced with respect to pure SO₂. Electrolytes having a lower vapor pressure are produced. Unlike the above-described organic electrolytes, such SO₂-based electrolytes have the advantage of not being combustible. Safety risks caused by the combustibility of the electrolyte can therefore be ruled out.

For example, EP 1 201 004 B1 (hereinafter referred to as [V3]) discloses an SO₂-based electrolyte having the composition LiAlCl₄*SO₂ in combination with a positive LiCoO₂ electrode. In order to prevent interfering decomposition reactions when the rechargeable battery cell is overcharged above a potential of from 4.1 to 4.2 volts, such as the undesirable formation of chlorine (Cl₂) from lithium tetrachloroaluminate (LiAlCl₄), [V3] proposes the use of an additional salt.

EP 2 534 719 B 1 (hereinafter referred to as [V4]) also discloses an SO₂-based electrolyte comprising, inter alia, LiAlCl₄ as the conducting salt. Together with the SO₂, this LiAlCl₄ forms complexes of the formula LiAlCl₄*1.5 mol SO₂ or LiAlCl₄*6 mol SO₂, for example. Lithium iron phosphate (LiFePO₄) is used as the positive electrode. LiFePO₄ has a lower charging potential (3.7 V) compared with LiCoO₂ (4.2 V). The problem of undesirable overcharging reactions does not occur in this rechargeable battery cell, since potentials of 4.1 volts, which damage the electrolyte, are not reached.

One disadvantage that, among others, also occurs in this SO₂-based electrolyte consists in that any hydrolysis products produced in the presence of residual amounts of water react with the cell components of the rechargeable battery cell and thereby lead to the formation of undesirable byproducts. On account thereof, when producing such rechargeable battery cells having an SO₂-based electrolyte, the residual water content in the electrolyte and the cell components must be minimized.

Another problem encountered by the SO₂-based electrolyte consists in that several conducting salts, in particular those also known for organic lithium-ion cells, are not soluble in SO₂. Measurements showed that SO₂ is a poor solvent for several salts, such as lithium fluoride (LiF), lithium bromide (LiBr), lithium sulfate (Li₂SO₄), lithium hexafluoroarsenate (LiAsF₆), lithium tetrafluoroborate (LiBF₄), trilithium hexafluoroaluminate (Li₃AlF₆), lithium hexafluoroantimonate (LiSbF₆), lithium-bis(trifluoromethanesulfonyl)imide (LiTFSI), lithium metaborate (LiBO₂), lithium aluminate (LiAlO₂), lithium triflate (LiCF₃SO₃) and lithium chlorosulfonate (LiSO₃Cl). The solubility of these salts in SO₂ is approx. 10⁻²-10⁻⁴ mol/l (Table 1). It may be assumed that only low degrees of conductivity are provided at these low concentrations, which are not sufficient for a rechargeable battery cell to operate appropriately.

TABLE 1
Solubility of Various Salts in SO₂

| | Solubility/ | | Solubility/ |
|---|---|---|---|
| Salt | mol/l in SO₂ | Salt | mol/l in SO₂ |
| LIF | 2.1 · 10⁻³ | LiPF₆ | 1.5 · 10⁻² |
| LiBr | 4.9 · 10⁻³ | LiSbF₆ | 2.8 · 10⁻⁴ |
| Li₂SO₄ | 2.7 · 10⁻⁴ | CF₃SO₂NLiSO₂CF₃ | 1.5 · 10⁻² |
| Li₃PO₄ | — | LiBO₂ | 2.6 · 10⁻⁴ |
| Li₃AlF₆ | 2.3 · 10⁻³ | LiAlO₂ | 4.3 · 10⁻⁴ |
| LiBF₄ | 1.7 · 10⁻³ | LiCF₃SO₃ | 6.3 · 10⁻⁴ |
| LiAsF₆ | 1.4 · 10⁻³ | | |

In order to improve the possible uses and properties of SO₂-based electrolytes and rechargeable battery cells containing these electrolytes, the object of this disclosure is to provide an SO₂-based electrolyte that, with respect to the electrolyte known in the art,
has a broad electrochemical window such that no oxidative electrolyte decomposition occurs at the positive electrode;
forms a stable cover layer on the negative electrode, wherein the cover layer capacitance should be low and additional reductive electrolyte decomposition does not occur at the negative electrode during further operation;
makes it possible to operate rechargeable battery cells comprising high-voltage cathodes as a result of a broad electrochemical window;
has good solubility for conducting salts and is therefore a good ion conductor and electronic insulator so that ion transfer can be facilitated and self-discharge can be kept to a minimum;
is also inert with respect to other components of the rechargeable battery cell, such as separators, electrode materials and cell packaging materials,
is robust with respect to various types of improper use, such as improper electrical, mechanical or thermal use, and
comprises increased stability with respect to residual amounts of water in the cell components of rechargeable battery cells.

Such electrolytes should in particular be usable in rechargeable battery cells that simultaneously have very good electrical energy and performance data, high operational reliability and service life, in particular a high number of available charge and discharge cycles, without the electrolyte thereby being decomposed during operation of the rechargeable battery cell.

On the other hand, the object of this disclosure consists in providing a rechargeable battery cell that contains an SO₂-based electrolyte and has the following with respect to the rechargeable battery cells known in the art:
improved electrical performance data, in particular a high energy density,
improved overcharging capacity and total discharging capacity,
reduced self-discharging,
increased service life, in particular a high number of available charge and discharge cycles,
reduced overall weight,
increased operational reliability, including under difficult environmental conditions in a vehicle, and
reduced production costs.

This object is achieved by an SO₂-based electrolyte having the features of claim 1 and by a rechargeable battery cell having the features of claim 15. Advantageous embodiments of the electrolyte according to this disclosure are specified in claims 2 to 14. Claims 16 to 25 describe advantageous developments of the rechargeable battery cell according to this disclosure.

An SO₂-based electrolyte according to this disclosure for a rechargeable battery cell comprises at least a first conducting salt of formula (I)

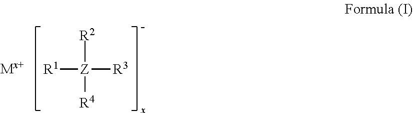

wherein
m is a metal selected from the group formed of alkali metals, earth alkali metals, metals from Group 12 of the periodic table of elements and aluminum;
x is an integer from 1 to 3;
the substituents R¹ and R² are selected, independently of one another, from the group formed of a halogen atom, a hydroxyl group, an —OR⁵ chemical group and a chelating ligand, which is collectively formed by at least two of the substituents R², R³ and R⁴ and is coordinated to Z;
the substituent R³ is selected from the group formed by a hydroxyl group, an —OR⁵ chemical group and a chelating ligand, which is collectively formed by at least two of the substituents R², R³ and R⁴ and is coordinated to Z;
the substituent R⁴ is selected from the group formed by a halogen atom, a hydroxyl group and a chelating ligand, which is collectively formed by at least two of the substituents R², R³ and R⁴ and is coordinated to Z;
the substituent R⁵ is selected from the group formed by C₁-C₁₀ alkyl, C₂-C₁₀ alkenyl, C₂-C₁₀ alkenyl, C₃-C₁₀ cycloalkyl, C₆-Cl₁₄ aryl and C₅-Cl₁₄ heteroaryl; and
Z is aluminum or boron.

The substituents R¹, R², R³ and R⁴ are therefore selected, independently of one another, from the group formed by the halogen atom, the hydroxyl group (—OH) and the —OR⁵ chemical group, wherein R¹, R², R³ and R⁴ are neither four halogen atoms nor four —OR⁵ chemical groups, in particular alkoxy groups. Within the context of this disclosure, the wording “chelating ligand collectively formed by at least two of the substituents R², R³ and R⁴ and coordinated to Z” is understood to mean that at least two of the substituents R¹, R², R³ and R⁴ can be bridged to one another, wherein this process of bridging two substituents leads to the formation of a bidentate chelating ligand. For example, the chelating ligand can be a bidentate chelating ligand according to the formula —O—R⁵—O—. In order to form this —O—R⁵—O— chelating ligand, the first substituent R1 can preferably have the structure of an OR⁵ group and the second substituent R² can preferably have the structure of a hydroxyl group, which are connected to one another in their bridged state by the formation of a chemical bond, and therefore have the above-mentioned formula —O—R⁵—O—. Such chelating ligands can comprise the following structural formulae, for example:

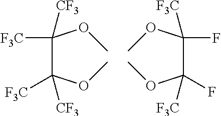

The chelating ligand is coordinated to the central atom Z and forms a chelate complex. In the case of the bidentate —O—R⁵—O— chelating ligand, the two oxygen atoms are coordinated to the central atom Z. Such chelate complexes can be synthetically produced, as in Example 1 described below. The term “chelate complex” means complex compounds in which a polydentate ligand (having more than one lone pair) occupies at least two coordination sites (binding sites) of the central atom. The chelating ligand can also be a polydentate ligand if three or four of the substituents R¹, R², R³ and R⁴ are bridged to one another.

The SO₂-based electrolyte according to this disclosure not only contains SO₂ as an additive in a low concentration but in concentrations at which the mobility of the ions of the first conducting salt, which is contained in the electrolyte and causes the transfer of charge, is, at least in part, largely or even fully ensured by the SO₂. The first conducting salt is dissolved in the electrolyte and demonstrates very good solubility therein. Together with the gaseous SO₂, it can form a liquid solvate complex, in which the SO₂ is bound. In this case, the vapor pressure of the liquid solvate complex is considerably reduced with respect to pure SO₂ and electrolytes having a low vapor pressure are formed. However, within the context of this disclosure, it may also be possible, depending on the chemical structure of the first conducting salt of formula (I), for the vapor pressure not to be reduced when producing the electrolyte according to this disclosure. In the latter case, it is preferable to work at a low temperature or under pressure when producing the electrolyte according to this disclosure. The electrolyte can also contain a plurality of conducting salts of formula (I) that differ from one another in terms of their chemical structure.

Within the context of this disclosure, the term “C₁-C₁₀ alkyl” includes linear or branched saturated hydrocarbon groups having one to ten carbon atoms. These in particular include methyl, ethyl, n-propyl, isopropyl, n-butyl, sec-butyl, iso-butyl, tert-butyl, n-pentyl, iso-pentyl, 2,2-dimethylpropyl, n-hexyl, iso-hexyl, 2-ethylhexyl, n-heptyl, iso-heptyl, n-octyl, iso-octyl, n-nonyl, n-decyl and the like.

Within the context of this disclosure, the term “C₂-C₁₀ alkenyl” includes unsaturated linear or branched hydrocarbon groups having two to ten carbon atoms, wherein the hydrocarbon groups comprise at least one C—C double bond. These in particular include ethenyl, 1-propenyl, 2-propenyl, 1-n-butenyl, 2-n-butenyl, iso-butenyl, 1-pentenyl, 1-hexenyl, 1-heptenyl, 1-octenyl, 1-nonenyl, 1-decenyl and the like.

Within the context of this disclosure, the term “C₂-C₁₀ alkenyl” includes unsaturated linear or branched hydrocarbon groups having two to ten carbon atoms, wherein the hydrocarbon groups comprise at least one C—C triple bond. These in particular include ethinyl, 1-propinyl, 2-propinyl, 1-n-butinyl, 2-n-butinyl, iso-butinyl, 1-pentinyl, 1-hexinyl, 1-heptinyl, 1-octinyl, 1-noninyl, 1-decinyl and the like.

Within the context of this disclosure, the term “C₃-C₁₀ cycloakyl” includes cyclic saturated hydrocarbon groups having three to ten carbon atoms. These in particular include cyclopropyl, cyclobutyl, cyclopentyl, cyclohexyl, cycloheptyl, cyclohexyl, cyclononyl and cyclodecanyl.

Within the context of this disclosure, the term “C₆-C₁₄ aryl” includes aromatic hydrocarbon groups having six to fourteen annular carbon atoms. These in particular include phenyl (C₆H₅ group), naphthyl (C₁₀H₇ group) and anthracyl (C₁₄H₉ group).

Within the context of this disclosure, the term “C₅-C₁₄ heteroaryl” includes aromatic hydrocarbon groups having five to fourteen annular hydrocarbon atoms, in which at least one hydrocarbon atom is replaced or exchanged with a nitrogen, oxygen or sulfur atom. These in particular include pyrrolyl, furanyl, thiophenyl, pyrridinyl, pyranyl, thiopyranyl and the like.

Such an electrolyte is advantageous over the electrolyte known in the art in that the first conducting salt therein has higher oxidation stability and therefore displays substantially no destruction at higher cell voltages. This electrolyte preferably has oxidation stability at least up to a potential of 4.0 volts, more preferably at least up to a potential of 4.2 volts, more preferably at least up to a potential of 4.4 volts, more preferably at least up to a potential of 4.6 volts, more preferably at least up to a potential of 4.8 volts and particularly preferably at least up to a potential of 5.0 volts. Therefore, when using such an electrolyte in a rechargeable battery cell, the electrolyte is either only marginally decomposed or not at all within the working potentials of both electrodes of the rechargeable battery cell. As a result, the service life of the electrolyte is considerably increased in comparison with the electrolyte known in the art. Furthermore, such an electrolyte is also resistant to low temperatures. Provided that only a small amount of water (in the ppm range) remains in the electrolyte, unlike the SO₂-based electrolytes known in the art, which are considerably less aggressive with respect to the cell components, the electrolyte or the first conducting salt forms hydrolysis products together with the water. On account thereof, the absence of water in the electrolyte plays a less important role compared with the SO₂-based electrolytes known in the art that comprise the conducting salt LiAlCl₄. These advantages of the electrolyte according to this disclosure outweigh the disadvantage caused by the fact that the first conducting salt of formula (I) has a considerably larger anion size than the conducting salts known in the art. This larger anion size leads to the first conducting salt of formula (I) having a lower degree of conductivity than the conductivity of LiAlCl₄.

Another aspect of this disclosure provides a rechargeable battery cell. This rechargeable battery cell contains the above-mentioned electrolyte according to this disclosure or an electrolyte according to one of the advantageous embodiments of the electrolyte according to this disclosure described below. Furthermore, the rechargeable battery cell according to this disclosure comprises an active metal, at least one positive electrode, at least one negative electrode and a housing.

### Electrolyte

Advantageous embodiments of the electrolyte according to this disclosure will be described hereinafter:

In a first advantageous embodiment of the electrolyte according to this disclosure, the substituent R⁵ is selected from the group formed by
C₁-C₆ alkyl; preferably C₂-C₄ alkyl; particularly preferably the alkyl groups 2-propyl, methyl and ethyl;
C₂-C₆ alkenyl; preferably C₂-C₄ alkenyl; particularly preferably the alkenyl groups ethenyl and propenyl;
C₂-C₆ alkenyl; preferably C₂-C₄ alkenyl;
C₃-C₆ cycloalkyl;
phenyl; and
C₅-C₇ heteroaryl.

In the case of this advantageous embodiment of the electrolyte according to this disclosure, the term “C₁-C₆ alkyl” includes linear or branched saturated hydrocarbon groups having one to six hydrocarbon groups, in particular methyl, ethyl, n-propyl, isopropyl, n-butyl, sec-butyl, iso-butyl, tert-butyl, n-pentyl, iso-pentyl, 2,2-dimethylpropyl, n-hexyl and iso-hexyl. Among these, C₂-C₄ alkyls are preferable. The C₂-C₄ alkyls 2-propyl, methyl and ethyl are particularly preferred.

In the case of this advantageous embodiment of the electrolyte according to this disclosure, the term “C₂-C₆ alkenyl” includes unsaturated linear or branched hydrocarbon groups having two to six carbon atoms, wherein the hydrocarbon groups comprise at least one C—C double bond. These in particular include ethenyl, 1-propenyl, 2-propenyl, 1-n-butenyl, 2-n-butenyl, iso-butenyl, 1-pentenyl and 1-hexenyl, C₂-C₄ alkenyls being preferred. Ethenyl and 1-propenyl are particularly preferred.

In the case of this advantageous embodiment of the electrolyte according to this disclosure, the term “C₂-C₆ alkenyl” includes unsaturated linear or branched hydrocarbon groups having two to six carbon atoms, wherein the hydrocarbon groups comprise at least one C—C triple bond. These in particular include ethinyl, 1-propinyl, 2-propinyl, 1-n-butinyl, 2-n-butinyl, iso-butinyl, 1-pentinyl and 1-hexinyl. Among these, C₂-C₄ are preferred.

In the case of this advantageous embodiment of the electrolyte according to this disclosure, the term “C₃-C₆ cycloalkyl” includes cyclic saturated hydrocarbon groups having three to six carbon atoms. These in particular include cyclopropyl, cyclobutyl, cyclopentyl and cyclohexyl.

In the case of this advantageous embodiment of the electrolyte according to this disclosure, the term “C₅-C₇ heteroaryl” includes phenyl and naphthyl.

In order to improve the solubility of the first conducting salt in the SO₂-based electrolyte, at least a single atom or an atom group of the substituent R⁵ is substituted by a halogen atom, in particular a fluorine atom, or by a chemical group, wherein the chemical group is selected from the group formed by C₁-C₄ alkyl, C₂-C₄ alkenyl, C₂-C₄ alkenyl, phenyl, benzyl and fully and partially halogenated, in particular fully and partially fluorinated, C₁-C₄ alkyl, C₂-C₄ alkenyl, C₂-C₄ alkenyl, phenyl and benzyl. The chemical groups C₁-C₄ alkyl, C₂-C₄ alkenyl, C₂-C₄ alkenyl, phenyl and benzyl have the same properties and chemical structures as the above-described hydrocarbon groups.

Provided that one to three of the substituents R², R³ and R⁴ are hydroxyl groups (—OH groups), the hydrogen atom (H) of one to three of these hydroxyl groups can also be substituted by the chemical group selected from the group formed by C₁-C₄ alkyl, C₂-C₄ alkenyl, C₂-C₄ alkenyl, phenyl, benzyl and fully and partially halogenated, in particular fully and partially fluorinated, C₁-C₄ alkyl, C₂-C₄ alkenyl, C₂-C₄ alkenyl, phenyl and benzyl. The chemical groups C₁-C₄ alkyl, C₂-C₄ alkenyl, C₂-C₄ alkenyl, phenyl and benzyl have the same properties and chemical structures as the above-described hydrocarbon groups.

A particularly high degree of solubility of the first conducting salt in the SO₂-based electrolyte can be achieved by at least one atom group of the substituent R⁵ preferably being a CF₃ group or an OSO₂CF₃ group.

In another advantageous embodiment of the electrolyte according to this disclosure, the first conducting salt is selected from the group formed by

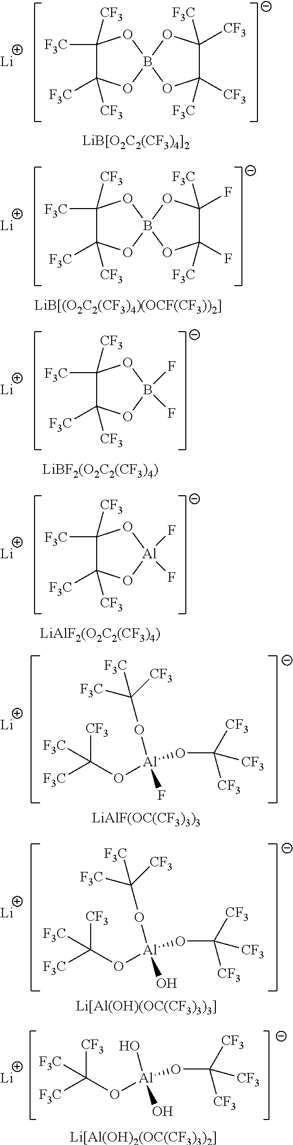

In order to adjust the conductivity and/or other features of the electrolyte to a desired value, in another advantageous embodiment the electrolyte comprises at least a second conducting salt that differs from the first conducting salt of formula (I). This means that the electrolyte can contain one, or even a plurality of, second conducting salt(s) in addition to the first conducting salt that differs from the first conducting salt in terms of its chemical composition and its chemical structure.

In an advantageous embodiment of the electrolyte according to this disclosure, the second conducting salt comprises the formula (II)

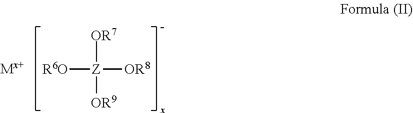

In Formula (II), M is a metal selected from the group formed of alkali metals, earth alkali metals, metals from Group 12 of the periodic table of elements and aluminum. x is an integer from 1 to 3. The substituents R⁶, R⁷, R⁸ and R⁹ are selected, independently of one another, from the group formed by C₁-C₁₀ alkyl, C₂-C₁₀ alkenyl, C₂-C₁₀ alkenyl, C₃-C₁₀ cycloalkyl, C₆-C₁₄ aryl and C₅-C₁₄ heteroaryl. The central atom Z is either aluminum or boron. In another advantageous embodiment of the rechargeable battery cell, the substituents R⁶, R⁷, R⁸ and R⁹ are substituted by at least one halogen atom and/or by at least one chemical group in order to improve the solubility of the second conducing salt of formula (II) in the SO₂-based electrolyte, wherein the chemical group is selected from the group formed by C₁-C₄ alkyl, C₂-C₄ alkenyl, C₂-C₄ alkenyl, phenyl and benzyl. In this context, “substituted” means that individual atoms or atom groups of the substituents R⁶, R⁷, R⁸ and R⁹ are replaced by the halogen atom and/or by the chemical group. The chemical groups C₁-C₁₀ alkyl, C₂-C₁₀ alkenyl, C₂-C₁₀ alkenyl, C₃-C₁₀ cycloalkyl, C₆-C₁₄ aryl and C₅-C₁₄ heteroaryl have the same properties and chemical structures as the hydrocarbon groups described for the first conducting salt of formula (I).

A particularly high degree of solubility of the second conducting salt of formula (II) in the SO₂-based electrolyte can be achieved by at least one of the substituents R⁶, R⁷, R⁸ and R⁹ being a CF₃ group or an OSO₂CF₃ group.

In another advantageous embodiment of the electrolyte according to this disclosure, the second conducting salt is an alkali metal compound, in particular a lithium compound. The alkali metal compound or the lithium compound is selected from the group formed by an aluminate, a halogenide, an oxalate, a borate, a phosphate, an arsenate and a gallate. The second conducting salt is preferably a lithium tetrahalogenoaluminate, in particular LiAlCl₄.

Furthermore, in another advantageous embodiment, the electrolyte contains at least one additive. This additive is preferably selected from the group formed by vinylene carbonate and the derivatives thereof, vinyl ethylene carbonate and the derivatives thereof, methyl ethylene carbonate and the derivatives thereof, lithium bis(oxolato)borate, lithium difluoro(oxalato)borate, lithium tetrafluoro(oxalato)phosphate, lithium oxalate, 2-vinylpyridine, 4-vinylpyridine, cyclic exomethylene carbonate, sultones, cyclic and acyclic sulfonates, acyclic sulfites, cyclic and acyclic sulfinates, organic esters of inorganic acids, acyclic and cyclic alkanes, which acyclic and cyclic alkanes have a boiling point at 1 bar of at least 36° C., aromatic compounds, halogenated cyclic and acyclic sulfonyl imides, halogenated cyclic and acyclic phosphate esters, halogenated cyclic and acyclic phosphines, halogenated cyclic and acyclic phosphites, halogenated cyclic and acyclic phosphazenes, halogenated cyclic and acyclic silylamines, halogenated cyclic and acyclic halogenated esters, halogenated cyclic and acyclic amides, halogenated cyclic and acyclic anhydrides and halogenated organic heterocyclic compounds.

Based on the overall weight of the electrolyte composition, in another advantageous embodiment the electrolyte comprises the following composition:
(i) 5 to 99.4 wt. % sulfur dioxide,
(ii) 0.6 to 95 wt. % of the first conducting salt,
(iii) 0 to 25 wt. % of the second conducting salt, and
(iv) 0 to 10 wt. % of the additive.

As already mentioned above, the electrolyte may comprise not only a first conducting salt of formula (I) and a second conducting salt, but also a plurality of first conducting salts of formula (I) and a plurality of second conducting salts. In the latter case, the above-mentioned percentages also include a plurality of first conducting salts and a plurality of second conducting salts. The molar concentration of the first conducting salt is in the range of from 0.05 mol/l to 10 mol/l, preferably from 0.1 mol/l to 6 mol/l and particularly preferably from 0.2 mol/l to 3.5 mol/l, based on the overall volume of the electrolyte.

Another advantageous embodiment of the rechargeable battery cell according to this disclosure provides that the electrolyte contains at least 0.1 mol of SO₂, preferably at least 1 mol of SO₂, more preferably at least 5 mol of SO₂, more preferably at least 10 mol of SO₂ and particularly preferably at least 20 mol of SO₂ per mol of conducting salt. The electrolyte can also contain very high mole fractions of SO₂, the preferred upper boundary being specifiable as 2,600 mol of SO₂ per mol of conducting salt and upper limits of 1,500, 1,000, 500 and 100 mol of SO₂ per mol of conducting salt are more preferred, in this order. The term “per mol of conducting salt” refers, in this case, to all conducting salts in the electrolyte. SO₂-based electrolytes having such a concentration ratio between the SO₂ and the conducting salt are advantageous in that they can dissolve a greater amount of conducting salt compared with the electrolytes known in the art, which are based on an organic solvent mixture, for example. Within the context of this disclosure, it has been established that an electrolyte having a relatively low concentration of conducting salt is surprisingly advantageous despite the associated higher vapor pressure, in particular with regard to the stability thereof across several charge and discharge cycles of the rechargeable battery cell. The concentration of SO₂ in the electrolyte affects the conductivity thereof. Therefore, the selection of the SO₂ concentration can be used to adapt the conductivity of the electrolyte to the planned use of a rechargeable battery cell operated using this electrolyte.

The overall content of SO₂ and the first conducting salt can be greater than 50 weight percent (wt. %) of the weight of the electrolyte, preferably greater than 60 wt. %, more preferably greater than 70 wt. %, more preferably greater than 80 wt. %, more preferably greater than 85 wt. %, more preferably greater than 90 wt. %, more preferably greater than 95 wt. % or more preferably greater than 99 wt. %.

The electrolyte can contain at least 5 wt. % of SO₂ based on the overall amount of the electrolyte in the rechargeable battery cell, wherein values of 20 wt. % of SO₂, 40 wt. % of SO₂ and 60 wt. % of SO₂ are more preferable. The electrolyte can also contain up to 95 wt. % of SO₂, wherein maximum values of 80 wt. % SO₂ and 90 wt. % SO₂ are preferred in this order.

Within the context of this disclosure, the electrolyte preferably only comprises a small percentage of at least one organic solvent, or even none whatsoever. The proportion of organic solvents in the electrolyte, which is present in the form of a solvent, or a mixture of a plurality of solvents, can preferably be no more than 50 wt. % of the weight of the electrolyte. Lower percentages of no more than 40 wt. %, no more than 30 wt. %, no more than 20 wt. %, no more than 15 wt. %, no more than 10 wt. %, no more than 5 wt. % or no more than 1 wt. % of the weight of the electrolyte are particularly preferred. The electrolyte is more preferably free of organic solvents. With only a low percentage of organic solvents or even the complete absence thereof, the electrolyte is almost or completely inflammable. This increases the operational reliability of a rechargeable battery cell operated using such an SO₂-based electrolyte. The SO₂-based electrolyte is particularly preferably substantially free of organic solvents.

### Active Metal

Advantageous developments of the rechargeable battery cell according to this disclosure will be described in the following with regard to the active metal:

In a first advantageous development of the rechargeable battery cell, the active metal is
an alkali metal, in particular lithium or sodium;
an earth alkali metal, in particular calcium;
a metal from Group 12 of the periodic table, in particular zinc; or
aluminum.

### Negative Electrode

Advantageous developments of the rechargeable battery cell according to this disclosure will be described in the following with respect to the negative electrode:

Another advantageous development of the rechargeable battery cell provides that the negative electrode is an insertion electrode. This insertion electrode contains an insertion material as the active material, in which the ions of the active metal are inserted when the rechargeable battery cell is charged and from which the ions of the active metal can be removed when the rechargeable battery cell is discharged. This means that the electrode processes cannot only take place at the surface of the negative electrode, but also inside the negative electrode. If, for example, a lithium-based conducting salt is used, lithium ions may be inserted in the insertion material when the rechargeable battery cell is charged and may be removed therefrom when the rechargeable battery cell is discharged. The negative electrode preferably contains carbon as the active material or insertional material, in particular in its modified form as graphite. However, within the context of this disclosure, the carbon is also present in the form of natural graphite (flake conveying means or rounded), synthetic graphite (mesophase graphite), graphited MesoCarbon MicroBeads (MCMB), carbon-coated graphite or amorphous carbon.

In another advantageous development of the rechargeable battery cell according to this disclosure, the negative electrode comprises lithium intercalation anode active materials, which do not contain any carbon, for example, lithium titanate (e.g., Li₄Ti₅O₁₂).

Another advantageous development of the rechargeable battery cell according to this disclosure provides that the negative electrode comprising anode active materials that form alloys together with lithium. These are, for example, lithium-storing metals and metal alloys (e.g., Si, Ge, Sn, SnCoₓC_{y}, SnSiₓ and the like) and oxides of the lithium-storing metals and metal alloys (e.g., SnOₓ, SiOₓ, oxidic glasses made of Sn, Si and the like).

In another advantageous development of the rechargeable battery cell according to this disclosure, the negative electrode contains conversion-type anode active materials. This conversion-type anode active materials can, for example, be transition metal oxides in the form of manganese oxides (MnOₓ), iron oxides (FeOₓ), cobalt oxides (CoOₓ), nickel oxides (NiOₓ), copper oxides (CuOₓ) or metal hydrides in the form of magnesium hydride (MgH₂), titanium dryided (TiH₂), aluminum hydride (AlH₃) and boron-, aluminum- and magnesium-based ternary hydrides and the like.

In another advantageous development of the rechargeable battery cell according to this disclosure, the negative electrode comprises a metal, in particular metal lithium.

Another advantageous development of the rechargeable battery cell according to this disclosure provides that the negative electrode is porous, the porosity preferably being no more than 50%, more preferably no more than 45%, more preferably no more than 40%, more preferably no more than 35%, more preferably no more than 30%, more preferably no more than 20% and particularly preferably no more than 10%. The porosity represents the ratio of the cavity volume to the overall volume of the negative electrode, wherein the cavity volume is formed by pores or cavities. This porosity leads to an increase in the inner surface of the negative electrode. Furthermore, the porosity reduces the density of the negative electrode and therefore also its weight. The individual pores of the negative electrode can be filled, preferably completely, with the electrolyte during operation.

Another advantageous development of the battery cell according to this disclosure provides that the negative electrode comprises a discharge element. This means that the negative electrode also comprises a discharge element in addition to the active material or insertion material. This discharge element is used to facilitate the required electronically conductive connection of the active material of the negative electrode. For this purpose, the discharge element is in contact with the active material that participates in the electrode reaction of the negative electrode. This discharge element can be planar in the form of a thin metal plate or a thin metal foil. The thin metal foil preferably comprises an openwork or mesh-like structure. The active material of the negative electrode is preferably applied to the surface of the thin metal plate or the thin metal foil. Such planar discharge elements have a thickness in the range of from 5 μm to 50 μm. A thickness of the planar discharge element in the range of from 10 μm to 30 μm is preferred. When using planar discharge elements, the negative electrode can have an overall thickness of at least 20 μm, preferably at least 40 μm and particularly preferably at least 60 μm. The maximum thickness is no more than 200 μm, preferably no more than 150 μm and particularly preferably no more than 100 μm. When using a planar discharge element, the surface area-specific apacitance of the negative electrode preferably comprises at least 0.5 mAh/cm², the following values being more preferred in this order: 1 mAh/cm², 3 mAh/cm², 5 mAh/cm² and 10 mAh/cm².

Furthermore, it is also possible for the discharge element to be three-dimensional in the form of a porous metal structure, in particular in the form of a metal foam. The term “three-dimensional porous metal structure” means any structure made of metal that, similarly to the thin metal plate or the metal foil, not only extends across the length and width of the planar electrode, but also across the thickness dimension thereof. The three-dimensional porous metal structure is porous in that the active material of the negative electrode can be introduced into the pores of the metal structure. The amount of active material that is introduced or applied relates to the charge of the negative electrode. If the discharge element is three-dimensional in the form of a porous metal structure, in particular in the form of a metal foam, the negative electrode preferably has a thickness of at least 0.2 mm, preferably at least 0.3 mm, more preferably at least 0.4 mm, more preferably at least 0.5 mm and particularly preferably at least 0.6 mm. In this case, the thickness of the electrodes is considerably greater than of negative electrodes used in organic lithium-ion cells. Another advantageous embodiment provides that, when using a three-dimensional discharge element in the form of a metal foam, in particular in the form of a metal foam, the surface area-specific capacitance of the negative electrode is preferably at least 2.5 mAh/cm², the following values being more preferable in this order: 5 mAh/cm², 10 mAh/cm², 15 mAh/cm², 20 mAh/cm², 25 mAh/cm² and 30 mAh/cm². When the discharge element is three-dimensional in the form of a porous metal structure, in particular in the form of a metal foam, the amount of the active material of the negative electrode, i.e., the charge of the electrode, based on its surface area, is at least 10 mg/cm², preferably at least 20 mg/cm², more preferably at least 40 mg/cm², more preferably at least 60 mg/cm², more preferably at least 80 mg/cm² and particularly preferably at least 100 mg/cm². This charge of the negative electrode has a positive effect on the charging process and the discharging process of the rechargeable battery cell.

In another advantageous development of the battery cell according to this disclosure, the negative electrode comprises at least one binder. This binder is preferably a fluorinated binder, in particular a polyvinyl fluoride and/or a terpolymer consisting of tetrafluoroethylene, hexafluoropropylene and vinylidene fluoride. However, it may also be a binder consisting of a polymer made from monomeric structural units of a conjugated carboxylic acid or of the alkali, earth alkali or ammonium salt of this conjugated carboxylic acid or a combination thereof. Furthermore, the binder can also consist of a polymer based on monomeric styrene and butadiene structural units. In addition, the binder can also be a binder from the group of carboxymethyl celluloses. The binder is preferably present in the negative electrode in a concentration of no more than 20 wt. %, more preferably no more than 15 wt. %, more preferably no more than 10 wt. %, more preferably no more than 7 wt. %, more preferably no more than 5 wt. % and particularly preferably no more than 2 wt. %, based on the overall weight of the negative electrode.

### Positive Electrode

Advantageous developments of the rechargeable battery cell according to this disclosure will be described in the following with respect to the positive electrode:

In another advantageous development of the battery cell according to this disclosure, the positive electrode contains at least one intercalation compound as the active material. Within the context of this disclosure, the term “intercalation compound” can be understood to mean a subcategory of the above-described insertion materials. This intercalation compound functions as a host matrix, which comprises spaces connected to one another. The ions of the active metal can diffuse into these spaces when the rechargeable battery cell is discharged, where they are inserted. As part of this process whereby the ions of the active metal are inserted, only minor structural changes occur in the host matrix, or none at all. The intercalation compound preferably comprises the composition LiₓM′_{y}M″_{z}Oₐ, in which
M′ is at least one metal selected from the group formed by the elements Ti, V, Cr, Mn, Fe, Co, Ni, Cu and Zn;
M″ is at least one element selected from the group formed by the elements of Groups 2, 3, 4, 5, 6, 7, 8, 9, 10, 11, 12, 13, 14, 15 and 16 of the periodic table of elements;
x and y are independently greater than 0;
a is greater or equal to 0; and
a is greater than 0.

The indices y and z relate to every metal and element that is represented by M′ and M″. For example, M′ comprises two metals M′₂ and M′₂, therefore the following applies for the y index: y=y1+y2, in which y1 and y2 represent the indices of the metals M′₂ and M′₂. The indices x, y, z and a have to be selected such that the charge remains neutral within the composition.

Compositions of the formula LiₓM′_{y}M″_{z}O₄ are preferable. In another advantageous development of the rechargeable battery cell according to this disclosure, M′ is iron and M″ is phosphorous in the composition LiₓM′_{y}M″_{z}O₄. In this case, the intercalation compound is lithium iron phosphate (LiFePO₄). Another advantageous development of the rechargeable battery cell according to this disclosure provides that M′ is manganese and M″ is cobalt in the composition LiₓM′_{y}M″_{z}O₄. In this case, the intercalation compound is lithium cobalt manganese oxide (LiCoMnO₄). By means of LiCoMnO₄, what are known as high-voltage electrodes can be produced for high-energy cells having a cell voltage of more than 5 volts. This LiCoMnO₄ is preferably free of Mn³⁺.

Another advantageous development of the rechargeable battery cell according to this disclosure provides that M′ consists of the metals nickel and manganese and M″ is cobalt. This relates to compositions of formula LiₓNi_{y1}Mn_{y2}Co_{z}O₂ (NMC). Examples of these lithium nickel manganese cobalt oxide intercalation compounds are LiNi_{1/3}Mn_{1/3}Co_{1/3}O₂ (NMC₁₁₁), LiNi_{0.6}Mn_{0.2}Co₂O₂ (NMC₆₂₂) and LiNi_{0.8}Mn_{0.1}Co_{0.1}O₂ (NMC₈₁₁).

High-voltage electrodes can be cycled in the rechargeable battery cell according to this disclosure at least up to an upper potential of 4.0 volts, more preferably at least up to a potential of 4.2 volts, more preferably at least up to a potential of 4.4 volts, more preferably at least up to a potential of 4.6 volts, more preferably at least up to a potential of 4.8 volts and particularly preferably at least up to a potential of 5.0 volts.

Another advantageous development of the rechargeable battery cell according to this disclosure provides that the positive electrode contains at least one metal compound. This metal compound is selected from the group formed by a metal oxide, a metal halogenide and a metal phosphate. The metal of this metal compound is preferably a transition metal having atomic numbers 22 to 28 in the periodic table of elements, in particular cobalt, nickel, manganese or iron.

Another advantageous development of the battery cell according to this disclosure provides that the positive electrode comprises a discharge element. This means that the positive electrode also comprises a discharge element in addition to the active material. This discharge element is used to facilitate the required electronically conductive connection of the active material of the position electrode. For this purpose, the discharge element is in contact with the active material participating in the electrode reaction of the positive electrode.

This discharge element can be planar in the form of a thin metal plate or a thin metal foil. The thin metal foil preferably comprises an openwork or mesh-like structure. The active material of the positive electrode is preferably applied to the surface of the thin metal plate or the thin metal foil. Such planar discharge elements have a thickness in the range of from 5 μm to 50 μm. A thickness of the planar discharge element in the range of from 10 μm to 30 μm is preferable. When using planar discharge elements, the positive electrode can have an overall thickness of at least 20 μm, preferably at least 40 μm and particularly preferably at least 60 μm. The maximum thickness is no more than 200 μm, preferably no more than 150 μm and particularly preferably no more than 100 μm. When using a planar discharge element, the surface area-specific capacitance of the positive electrode preferably comprises at least 0.5 mAh/cm², the following values being more preferable in this order: 1 mAh/cm², 3 mAh/cm², 5 mAh/cm² and 10 mAh/cm².

Furthermore, it is also possible for the discharge element of the positive electrode to be three-dimensional in the form of a porous metal structure, in particular in the form of a metal foam. The three-dimensional porous metal structure is porous such that the active material of the positive electrode can be introduced into the pores of the metal structure. The amount of active material that is introduced or applied relates to the charge of the positive electrode. If the discharge element is three-dimensional in the form of a porous metal structure, in particular in the form of a metal foam, the positive electrode preferably has a thickness of at least 0.2 mm, preferably at least 0.3 mm, more preferably at least 0.4 mm, more preferably at least 0.5 mm and particularly preferably at least 0.6 mm. Another advantageous embodiment provides that, when using a three-dimensional discharge element in the form of a metal foam, in particular in the form of a metal foam, the surface-specific capacitance of the positive electrode is preferably at least 2.5 mAh/cm², the following values being more preferable in this order: 5 mAh/cm², 10 mAh/cm², 15 mAh/cm², 20 mAh/cm², 25 mAh/cm² and 30 mAh/cm². If the discharge element is three-dimensional in the form of a porous metal structure, in particular in the form of a metal foam, the amount of the active material of the positive electrode, i.e., the charge of the electrode, based on its surface area, is at least 10 mg/cm², preferably at least 20 mg/cm², more preferably at least 40 mg/cm², more preferably at least 60 mg/cm², more preferably at least 80 mg/cm² and particularly preferably at least 100 mg/cm². This charge of the positive electrode has a positive effect on the process of charging and discharging the rechargeable battery cell.

In another advantageous development of the battery cell according to this disclosure, the positive electrode comprises at least one binder. This binder is preferably a fluorinated binder, in particular a polyvinyl fluoride and/or a terpolymer formed from tetrafluoroethylene, hexafluoropropylene and vinylidene fluoride. However, it may also be a binder consisting of a polymer formed from monomeric structural units of a conjugated carboxylic acid or of the alkali, earth alkali or ammonium salt of this conjugated carboxylic acid or of a combination thereof. Furthermore, the binder can also consist of a polymer based on monomeric styrene and butadiene structural units. In addition, the binder can also be a binder from the group of carboxymethyl celluloses. The binder is preferably present in the positive electrode in a concentration of no more than 20 wt. %, more preferably no more than 15 wt. %, more preferably no more than 10 wt. %, more preferably no more than 7 wt. %, more preferably no more than 5 wt. % and particularly preferably no more than 2 wt. %, based on the overall weight of the positive electrode.

### Structure of the Rechargeable Battery Cell

Advantageous developments of the rechargeable battery cell according to this disclosure will be described in the following with respect to the structure thereof:

In order to further improve the function of the rechargeable battery cell, another advantageous development of the rechargeable battery cell according to this disclosure provides that the rechargeable battery cell comprises a plurality of negative electrodes and a plurality of positive electrodes, which are alternately stacked in the housing. In this case, the positive electrodes and the negative electrodes are preferably electrically isolated from one another by separators.

The rechargeable battery cell can, however, also be formed as a wound cell in which the electrodes consist of thin layers wound together with a separator material. On the one hand, the separators spatially and electrically separate the positive electrode and the negative electrode and, on the other hand, the ions of the active metal, inter alia, can pass therethrough. In this way, large electrochemically active surfaces are formed that allow for a correspondingly high degree of current efficiency.

The separator can be made from a nonwoven fabric, a membrane, a woven fabric, a knitted fabric, an organic material, an inorganic material or from a combination thereof. Organic separators can consist of unsubstituted polyolefins (e.g., polypropylene or polyethylene), partially to fully halogen-substituted polyolefins (e.g., partially to fully fluorine-substituted, in particular PVDF, ETFE, PTFE), polyesters, polyamides or polysulfones. Separators containing a combination of organic and inorganic materials are, for example, glass fiber textile materials in which the glass fibers are provided with a suitable polymer coating. The coating preferably contains a polymer containing fluorine, such as polytetrafluoroethylene (PTFE), ethylene tetrafluoroethylene (ETFE), fluorinated ethylene propylene (FEP), THV (terpolymer of tetrafluoroethylene, hexafluoroethylene and vinylidene fluoride), a perfluoroalkoxy polymer (PFA), aminosilane, polypropylene or polyethylene (PE). The separator can also be folded in the housing of the rechargeable battery cell, for example, in the form of a “Z-folding.” In this Z-folding, a strip-type separator is folded in a z-like fashion by or around the electrodes. Furthermore, the separator can also be formed as a separator paper.

This disclosure also includes the fact that the separator can be formed as a covering, wherein every positive electrode or every negative electrode is covered by the covering. The covering can be made from a nonwoven fabric, a membrane, a woven fabric, a knitted fabric, an organic material, an inorganic material or from a combination thereof

Covering the positive electrode leads to more uniform ion migration and ion distribution in the rechargeable battery cell. The more uniform the ion distribution, in particular in the negative electrode, the higher the potential charge of the negative electrode comprising the active material, and therefore the available capacitance of the rechargeable battery cell, can be. At the same time, risks that may be associated with non-uniform charging and the resultant deposition of the active metal are avoided. These advantages mainly have an effect when the positive electrode of the rechargeable battery cell is covered by the covering.

The mass per unit area of the electrodes and the covering can preferably be adapted to match one another such that the overall dimensions of the covering of the electrodes and the external dimensions of the electrodes that are not covered match, at least with respect to one dimension.

The surface area of the covering can preferably be greater than the surface area of the electrode. In this case, the covering extends beyond a boundary of the electrode. Two layers of the covering that cover the electrode on either side can therefore be interconnected at the edge of the positive electrode by an edge connection.

In another advantageous embodiment of the rechargeable battery cell according to this disclosure, the negative electrodes comprise a covering while the positive electrodes have no covering.

Additional advantageous features of this disclosure will be described and explained in more detail in the following on the basis of drawings, examples and experiments.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 is a cross-sectional view of a first embodiment of a rechargeable battery cell according to this disclosure;

FIG. 2 is a detailed view of an electron-microscopic image of the three-dimensional porous structure of the metal foam of the first embodiment from FIG. 1;

FIG. 3 is a cross-sectional view of a second embodiment of a rechargeable battery cell according to this disclosure;

FIG. 4 shows a detail of the second embodiment from FIG. 3;

FIG. 5 is an exploded view of a third embodiment of the rechargeable battery cell according to this disclosure;

FIG. 6 shows a charging and discharging potential curve in volts [V] as a function of the level of charge of a half cell filled with the electrolyte X1 expressed as a percentage;

FIG. 7 shows a charging and discharging potential curve in volts [V] as a function of the level of charge of test full cells filled with the electrolyte X1 expressed as a percentage;

FIG. 8 shows the potential in [V] of two test full cells, which are filled with the 9%/91% electrolytes and the reference electrolyte, during charging, as a function of the capacitance, which is based on the theoretical capacitance of the negative electrode, when a cover layer is formed on the negative electrode;

FIG. 9 shows the discharging capacitance of two test full cells, which are filled with the 9%/91% electrolyte and the reference electrolyte, as a function of the cycle number;

FIG. 10 shows the potential in [V] of two test full cells, which are filled with the 30%/70% electrolytes and the reference electrolyte, during charging, as a function of the capacitance, which is based on the theoretical capacitance of the negative electrode, when a cover layer is formed on the negative electrode;

FIG. 11 shows the discharging capacities of two test full cells, which are filled with the 30%/70% electrolyte and the reference electrolyte, as a function of the cycle number; and

FIG. 12 shows the conductivity in [mS/cm] of the electrolyte X1 according to this disclosure as a function of the concentration.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

It shall be understood for purposes of this disclosure and appended claims that, regardless of whether the phrases “one or more” or “at least one” precede an element or feature appearing in this disclosure or claims, such element or feature shall not receive a singular interpretation unless it is made explicit herein. By way of non-limiting example, the terms “positive electrode,” “negative electrode,” “conductive salt,” and “binder,” to name just a few, should be interpreted wherever they appear in this disclosure and claims to mean “at least one” or “one or more” regardless of whether they are introduced with the expressions “at least one” or “one or more.” All other terms used herein should be similarly interpreted unless it is made explicit that a singular interpretation is intended.

FIG. 1 is a cross-sectional view of a first embodiment of a rechargeable battery cell 2 according to this disclosure. This rechargeable battery cell 2 is formed as a prismatic cell and comprises, inter alia, a housing 1. This housing 1 surrounds an electrode arrangement 3, which comprises three positive electrodes 4 and four negative electrodes 5. The positive electrodes 4 and the negative electrodes 5 are alternately stacked in the electrode arrangement 3. The housing 1 can, however, also house more positive electrodes 4 and/or negative electrodes 5. In general, it is preferable for the number of negative electrodes 5 to be one greater than the number of positive electrodes 4. As a result, the outer end faces of the electrode stack are formed by the electrode surfaces of the negative electrodes 5. The electrodes 4, 5 are connected to corresponding connecting contacts 9, 10 of the rechargeable battery cell 2 by means of electrode terminals 6, 7. The rechargeable battery cell 2 is filled with an SO₂-based electrolyte such that the electrolyte enters all pores or cavities, in particular inside the electrode 4,5, so as to fill them as fully as possible. The electrolyte is not visible in FIG. 1. In the present embodiment, the positive electrodes 4 contain an intercalation compound as the active material. This intercalation compound is LiCoMnO₄.

In the present embodiment, the electrodes 4, 5 are planar, i.e., as layers having a thickness that is smaller than their surface area. They are each separated from one another by separators 11. The housing 1 of the rechargeable battery cell 2 is substantially square, wherein the electrodes 4, 5 and the walls of the housing 1, shown in section, extend perpendicularly to the drawing plane and are substantially straight and flat. The rechargeable battery cell 2 can, however, also be formed as a wound cell, in which the electrodes consist of thin layers that are wound together with a separator material. The separators 11 spatially and electrically separate the positive electrode 4 and the negative electrode 5 and through which the ions of the active metal, inter alia, can pass. In this way, large electrochemically active surfaces are formed that allow for a correspondingly high degree of current efficiency.

Furthermore, the electrodes 4, 5 comprise a discharge element (not shown in FIG. 1), which is used to facilitate the required electronically conductive connection of the active material of the particular electrode. This discharge element is in contact with the active material (not shown in FIG. 1) that participates in the electrode reaction of the particular electrode 4, 5. The discharge element is formed as a porous metal foam. The metal foam extends across the thickness dimension of the electrodes 4, 5. The active material of the positive electrodes 4 and the negative electrodes 5 is introduced into the pores of this metal foam so as to uniformly fill the pores thereof across the entire thickness of the metal structure. In order to improve mechanical strength, the positive electrodes 4 contain a binder. This binder is a fluorine polymer. The negative electrodes 5 contain carbon as the active material in a form suitable as an insertion material for accepting lithium ions. The structure of the negative electrode 5 is similar to that of the positive electrode 4.

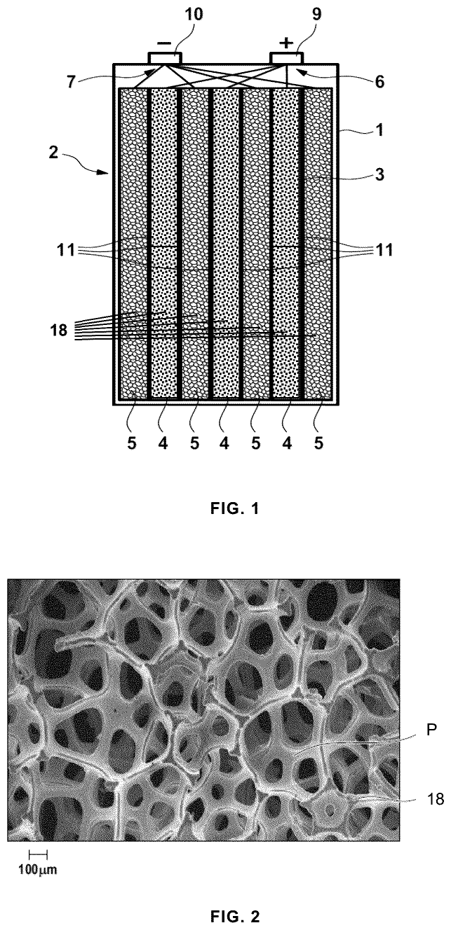

FIG. 2 shows an electron-microscopic image of the three-dimensional porous structure of the metal foam 18 of the first embodiment in FIG. 1. Using the stated scale, it can be seen that the pores P in the middle have a diameter of more than 100 μm, i.e., are relatively large.

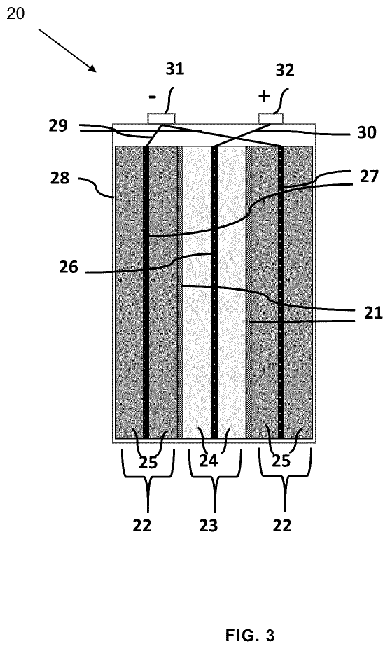

FIG. 3 is a cross-sectional view of a second embodiment of the rechargeable battery cell 20 according to this disclosure. This second embodiment differs from the first embodiment shown in FIG. 1 in that the electrode arrangement comprises one positive electrode 23 and two negative electrodes 22. The electrodes 22, 23 are each separated from one another by separators 21 and surrounded by a housing 28. The positive electrode 23 comprises a discharge element 26 in the form of a planar metal foil, to either side of which the active material 24 of the positive electrode 23 is applied. The negative electrode 22 likewise comprise a discharge element 27 in the form of a planar metal foil, to either side of which the active material 25 of the negative electrode 22 is applied. Alternatively, the planar discharge elements of the edge electrodes, i.e., the electrodes that form the ends the electrode stack, can be coated with active material on just one side. The non-coated side faces the wall of the housing 28. The electrodes 22, 23 are connected to corresponding connecting contacts 31, 32 of the rechargeable battery cell 20 by means of electrode terminals 29, 30.

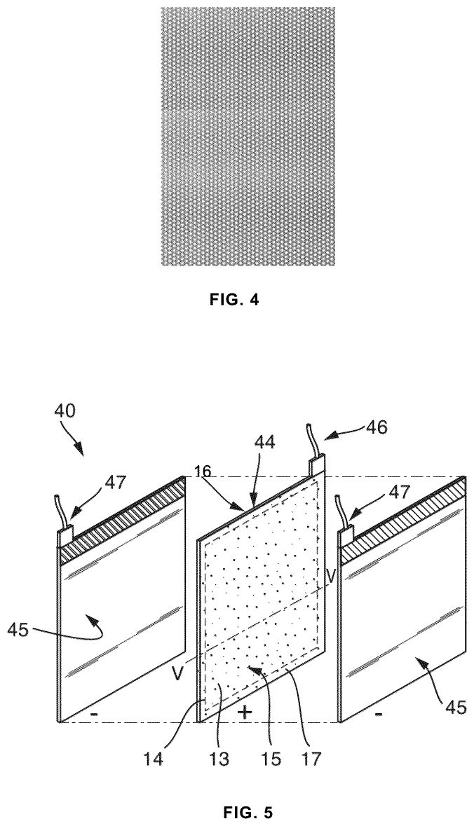

FIG. 4 shows the planar metal foil, which is used as a discharge element 26, 27 for the positive electrode 4 and the negative electrode 5 in the second embodiment from FIG. 3. This metal foil comprises an open-work or mesh-like structure having a thickness of 20 μm.

FIG. 5 is an exploded view of a third embodiment of the rechargeable battery cell 40 according to this disclosure. This third embodiment differs from the two above-mentioned embodiments in that the positive electrode 44 is covered by a covering 13, which is used as a separator. In this case, a surface area of the covering 13 is greater than a surface extension of the positive electrode 44, the boundary 14 of which is shown in FIG. 5 as a dashed line. Two layers 15, 16, which cover the positive electrode 44 on either side, of the covering 13 are connected to one another at the circumferential edge of the positive electrode 44 by an edge connection 17. The two negative electrodes 45 are not covered. The electrodes 44 and 45 can be contacted by means of the electrode terminals 46 and 47.

### Example 1: Production of a Reference Electrolyte

An SO₂-based reference electrolyte was produced for the experiments described below. For this purpose, a compound 1 (shown below) was first produced as a conducting salt of formula (II) according to a production method described in the following document, [V5]:
[V5] “I. Krossing, Chem. Eur J. 2001, 7, 490.”

This compound 1 originates from the family of polyfluoroalkoxy aluminates and was produced in hexane according to the following reaction equation, which starts with LiAlH₄ and the corresponding alcohol R—OH, where R¹═R²═R³═R⁴.

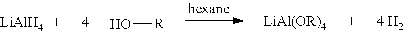

Compound 1 shown below having the following molecular or structural formulae was thereby formed:

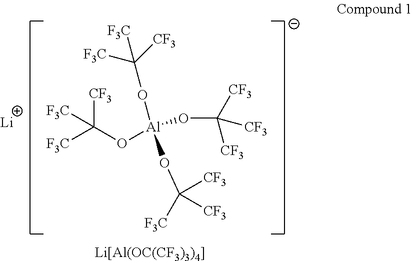

In order to produce the reference electrolyte, this compound 1 was dissolved in SO₂. The concentration of the conducting salt in the reference electrolyte was 0.6 mol/L.

### Example 2: Production of Embodiments of the Electrolyte According to This Disclosure

Conducting salts of formula (I) having chelating ligands were produced proceeding from the corresponding diols HO-R-OH according to a production method described in the following document, [V6]:
[V6] Wu Xu et al., Electrochem. Solid-State Lett. 2000, 3, 366-368.

The following reaction equation describes the production of compound X1, for example:

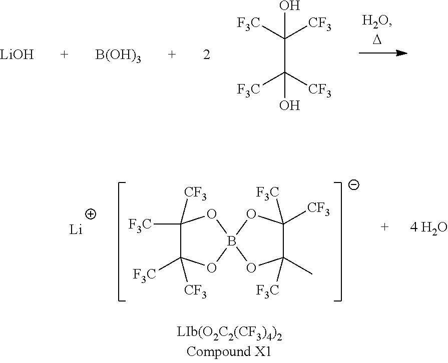

In order to purify it, compound X1 was first recrystallized. As a result, residues of the educts were removed from the conducting salt.

Conducting salts of formula (I), in which three alkoxy groups and one fluoride group are coordinated to the central atom, can be produced according to a production method described in the following document, [V7]:
[V7] A. Martens et al., Chem. Sci., 2018, 9, 7058-7068

The following compound X2 was used in the experiments:

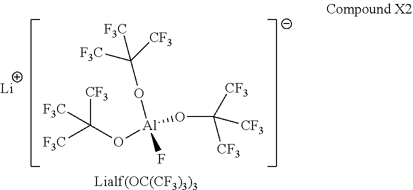

Conducting salts of formula (I), in which at least one alkoxy group and at least one hydroxyl group are coordinated to the central atom, can be produced by treating tetraalkoxy compounds with stoichiometric amounts of donor solvents. Therefore, the following compounds, X3 and X4, are produced, for example, by the reaction of Li[Al(OC(CF₃)₃)₄] with water:

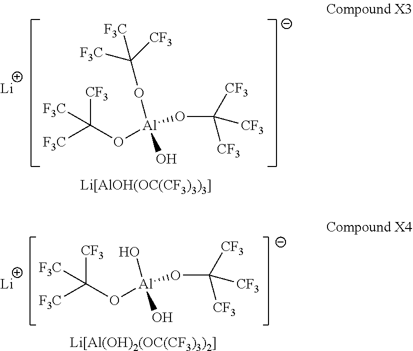

In order to produce the electrolytes X1, X2, X3 and X4, the compounds X1, X2, X3 and X4 were dissolved in SO₂. This production method was carried out at low temperatures or under pressure according to method steps 1 to 4 listed below:
1) producing the compounds X1, X2, X3 and X4 in a plunger having an ascending pipe;
2) evacuating the pressure piston,
3) introducing liquid SO₂, and
4) repeating steps 2+3 until the target amount of SO₂ has been added.

### Example 3: Production of Test Full Cells

The test full cells used in the experiments described below are rechargeable battery cells having two negative electrodes and one positive electrode, each of which were separated by a separator. The positive electrodes comprise an active material, a conductivity promotor, a binder and a discharge element made of nickel or aluminum. The active material of the positive electrode is mentioned in the relevant experiment. The negative electrodes contained graphite as the active material, a binder and a discharge element made of nickel or copper. If mentioned in the experiment, the negative electrodes can also contain a conductivity additive. The aim of the tests is, inter alia, to confirm the functionality of the various electrolytes in a battery cell according to this disclosure. The test full cells were each filled with the electrolytes required for the experiment, i.e., either with the reference electrolyte or an electrolyte X1, X2, X3 and X4 according to this disclosure.

For each experiment, a plurality of, i.e., two to four, identical test full cells were often produced. The results presented in the experiments are then averages of the measured values obtained for the identical test full cells.

### Example 4: Measurement in Test Full Cells

### Cover Layer Capacitance

The capacitance used up in the first cycle for forming a cover layer on the negative electrode is a key criterion regarding the quality of a battery cell. This cover layer is formed on the negative electrode the first time the test full cell is charged. In order to form this cover layer, lithium ions are irreversibly used up (cover layer capacitance) such that less cyclable capacitance is available to the test full cell. The cover layer capacitance in % of the theory used up to form the cover layer on the negative electrode is calculated according to the formula below:

Cover layer capacitance [in % of the theory]=(Q_{lad}(x mAh)−Qₑₙₜ(y mAh))/Q_{NEL}

Q_{lad} describes the amount of charge in mAh specified in the particular experiment; Qₑₙₜ describes the amount of charge in mAh that has been obtained the next time the test full cell is discharged. Q_{NEL} is the theoretical capacitance of the negative electrode used. The theoretical capacitance is calculated, for example, in the case of graphite, be to a value of 372 mAh/g.

### Discharging Capacitance

For measurements in test full cells, for example, the discharging capacitance is determined using the cycle number. For this purpose, the test full cells are charged up to a specific upper potential using a specific charge current strength. The corresponding upper potential is maintained until the charging current has sunk to a specific value. The test full cells are then discharged to a specific discharging potential using a specific discharging current strength. This charging method is referred to as an I/U charging process. This process is repeated depending on the desired number of cycles.

The upper potentials or the discharging potential and the particular charging and discharging current strengths are stated in the experiments. The value to which the charging current has to be lowered is also described in the experiments.

The term “upper potential” is used synonymously with the terms “charging potential,” “charging voltage,” “end-of-charge voltage” and “upper potential boundary.” The terms designate the voltage/the potential up to which a cell or battery is charged using a battery charging device.

The battery is preferably charged at a C-rate of C/2 and at a temperature of 22° C.

The term “discharging potential” is used synonymously with the term “lower cell voltage.” This designates the voltage/potential up to which a cell or battery is discharged using a battery charging device.

The battery is preferably discharged at a C-rate of C/2 and at a temperature of 22° C.

The discharging capacitance is obtained from the discharging current and the time until the criteria for ending the discharging process have been met. The associated drawings show averages for the discharging capacities as a function of the number of cycles. These averages for the discharging capacities are often standardized to 100% of the starting capacitance and expressed as a percent of the nominal capacitance.

### Experiment 1: Behavior of Negative Electrodes in Half Cells Comprising Electrolyte X1

The experiments were carried out in half cells comprising metal lithium as the counter and reference electrode. The working electrode was a graphite electrode. The half cells were filled with the electrolyte X1.

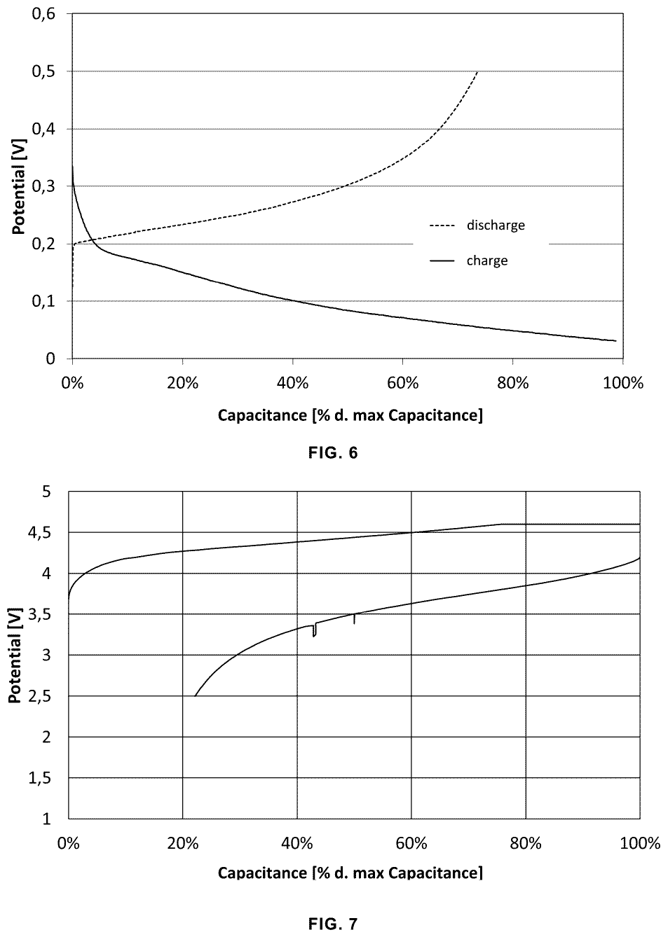

The half cell was charged to a potential of 0.03 volts and discharged to a potential of 0.5 volts at a charging/discharging rate of 0.02 C. FIG. 6 shows the potentials of the charging curve and discharging curve for the second cycle of the half cell. The solid curve corresponds to the potentials of the charging curve and the dashed curve corresponds to the potentials of the discharging curve.

The charging and discharging curves disclose typical battery behavior. The principal functionality of the electrolyte X1 in a half cell is therefore shown.

### Experiment 2: Behavior of Test Full Cells Comprising Electrolyte X1

The electrolyte X1 was tested in a test full cell for this experiment. The set up corresponded to the set up described in Example 3. The negative electrode had graphite as the active electrode material and nickel manganese cobalt oxide (NMC622) was used as the active electrode material for the positive electrode.

In order to determine the discharging capacitance, the test full cells were charged to a potential of 4.6 volts and discharged to a potential of 2.5 volts at a charging/discharging current strength of 100 mA.

FIG. 7 shows the potential curve when charging and discharging the test full cell in the second cycle. The potential curve shows typical battery behavior. The principal functionality of the electrolyte X1 in a battery cell is thus shown.

### Experiment 3: Behavior of Test Full Cells Having a Mixture of 9 wt. % of Electrolytes X2, X3 and X4 and 91 wt. % of Reference Electrolytes

In order to test electrolytes X2, X3 and X4, a mixture of these electrolytes was produced. 9 wt. % of this mixture were mixed with 91 wt. % of the reference electrolyte. The electrolyte thus obtained is referred to as “9%/91% electrolyte.” The 9%/91% electrolyte was used to carry out various experiments. On the one hand, the cover layer capacities of the electrolyte were determined. On the other hand, the discharging capacities in the electrolyte were determined. For comparison purposes, both experiments were also carried out in the reference electrolyte.

The reference electrolyte and the 9%/91% electrolyte were tested in a test full cell for this experiment. The set up corresponded to the set up described in Example 3. The negative electrode had graphite as the active electrode material, and nickel manganese cobalt oxide (NMC622) was used as the active electrode material in the positive electrode.

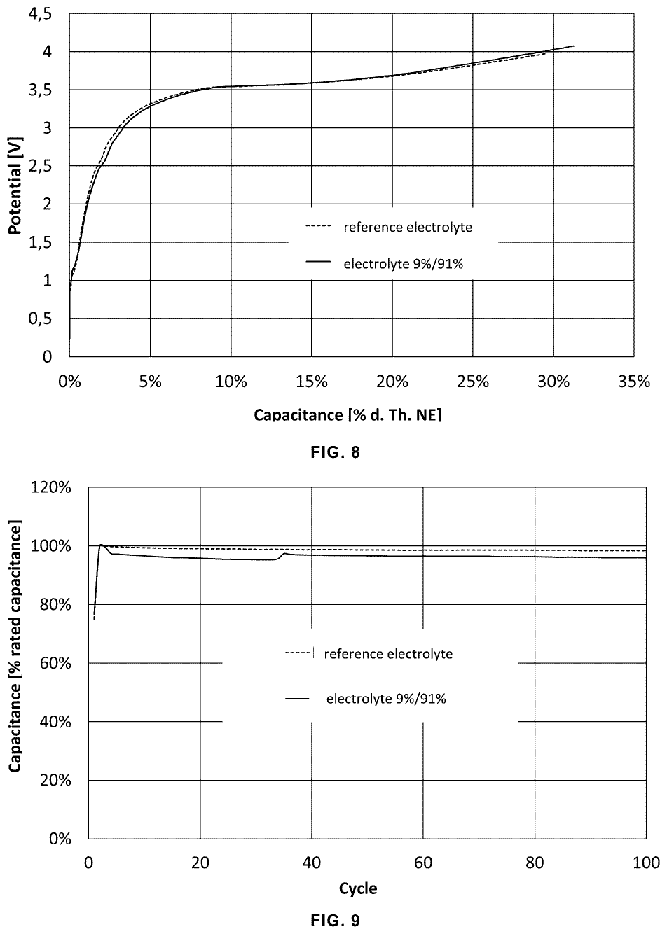

FIG. 8 shows the potential in volts [V] of the test full cells during charging as a function of the capacitance, which is based on the theoretical capacitance of the negative electrode. In this drawing, the dashed line shows the results for the reference electrolyte and the solid line shows the results for the 9%/91% electrolyte according to this disclosure. The two curves shown each show the results of a representative individual cell. First of all, the test full cells were charged up to a capacitance of 125 mAh using a current strength of 15 mA. Then the test full cells were discharged using a current strength of 15 mA until a potential of 2.5 volts was reached. The cover layer capacitance is determined from the behavior of the capacitance in this first cycle. The capacitance losses lie at 6.64% for the 9%/91% electrolyte and at 5.62% for the reference electrolyte. The capacitance for forming the cover layer is slightly higher for the electrolyte according to this disclosure than for the reference electrolyte. A value in the region of 6.6% is a very good result for the loss of capacitance.

In order to determine the discharging capacities (see Example 4), the two above-described test full cells were charged to a potential of 4.4 volts using a current strength of 100 mA after determining the cover layer capacitance. Discharging was then carried out to a discharging potential of 2.5 volts using a current strength of 100 mA.

FIG. 9 shows the discharging capacities in % [% of nominal capacitance] across 100 cycles of the test full cells as a function of the number of cycles. In this drawing, the dashed line shows the results for the reference electrolyte and the solid line shows the results for the 9%/91% electrolyte according to this disclosure. When measuring the test full cell comprising the 9%/91% electrolyte, the measurement encountered an interference between cycles 4 and 34. The values in this range of cycles are therefore slightly lower. From cycle 35, the interference was remedied. Both test full cells display a very flat curve for the discharging capacitance. The 9%/91% electrolyte is particularly suitable for operation in a battery cell.

### Experiment 4: Behavior of Test Full Cells Having a Mixture of 30 wt. % of Electrolytes X2, X3, X4 and 70 wt. % Reference Electrolyte

In order to further test electrolytes X2, X3 and X4, a mixture of these electrolytes was produced. This time, 30 wt. % of this mixture was mixed with 70 wt. % of the reference electrolyte. The electrolyte thus obtained is referred to as “30%/70% electrolyte.” Exactly the same tests were carried out using the 30%/70% electrolyte as for the 9%/91% electrolyte described in Experiment 3. The measuring parameters can be found in Experiment 3. On the one hand, the cover layer capacities of the electrolyte were determined. On the other hand, the discharging capacities in the electrolyte were determined. For comparison purposes, both experiments were also carried out in the reference electrolyte.

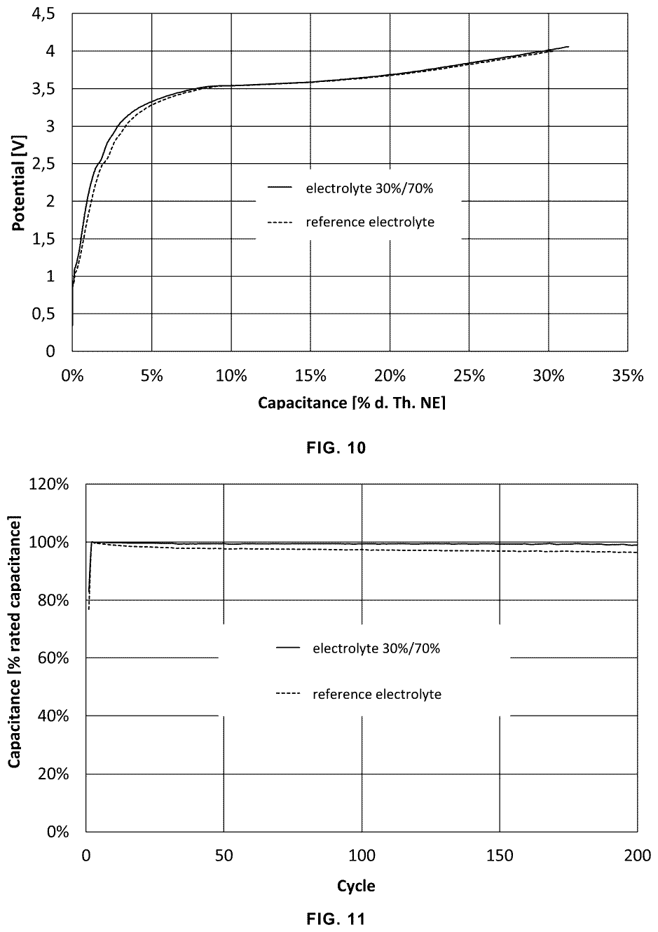

FIG. 10 shows the potential in volts of the test full cells when charging the cell as a function of the capacitance, which is based on the theoretical capacitance of the negative electrode. In this drawing, the dashed line shows the results for the reference electrolyte and the solid line shows the results for the 30%/70% electrolyte according to this disclosure. The losses of capacitance lie at 5.63% for the 30%/70% electrolyte and at 6.09% for the reference electrolyte. The capacitance for forming the cover layer is lower in the electrolyte according to this disclosure than in the reference electrolyte. A value in the region of 5.6% is an excellent result for the capacitance loss.

FIG. 11 shows the discharging capacities in % [% of nominal capacitance] across 200 cycles of the test full cells as a function of the number of cycles. In this drawing, the dashed line shows the results for the reference electrolyte and the solid line shows the results for the 30%/70% electrolyte according to this disclosure. Both test full cells show a very flat curve for the discharging capacitance, the curve for the 30%/70% capacitance being slightly more stable. The 30%/70% electrolyte is ideal for operation in a battery cell.

### Experiment 5: Determination of the Conductivity of Electrolyte X1

In order to determine the conductivity, electrolyte X1 was produced using various concentrations of compound X1. For each concentration of the compound, the conductivity of the electrolyte was determined using a conductive measuring method. In this case, after controlling the temperature, a four-electrode sensor was held in the solution so as to be in contact therewith and measured a measurement range of 0.02-500 mS/cm.

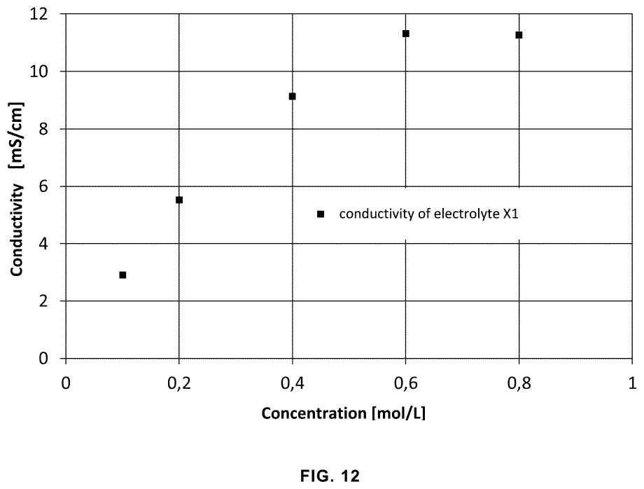

FIG. 12 shows the conductivity of electrolyte X1 as a function of the concentration of compound X1. A maximum conductivity at a concentration of 0.6 mol/L of compound X1 having a value of approx. 11.3 mS/cm can be seen.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. An SO₂-based electrolyte for a rechargeable battery cell, comprising a first conducting salt of formula (I): 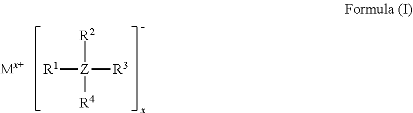
wherein;
m is a metal selected from the group consisting of alkali metals, alkali earth metals, metals from Group 12 of the periodic table of elements, and aluminum;
x is an integer from 1 to 3;
the substituents R¹ and R² are selected, independently of one another, from the group consisting of a halogen atom, a hydroxyl group, an —OR⁵ chemical group and a chelating ligand, which is collectively formed by at least two of the substituents R¹, R², R³ and R⁴ and is coordinated to Z;
the substituent R³ is selected from the group consisting of a hydroxyl group, an —OR⁵ chemical group and a chelating ligand, which is collectively formed by at least two of the substituents R¹, R², R³ and R⁴ and is coordinated to Z;
the substituent R⁴ is selected from the group consisting of a halogen atom, a hydroxyl group and a chelating ligand, which is collectively formed by at least two of the substituents R², R³ and R⁴ and is coordinated to Z;
the substituent R⁵ is selected from the group consisting of C₁-C₁₀ alkyl, C₂-C₁₀ alkenyl, C₂-C₁₀ alkynyl, C₃-C₁₀ cycloalkyl, C₆-C₁₄ aryl and C₅-C₁₄ heteroaryl; and
Z is aluminum or boron.

2. The electrolyte according to claim 1, wherein the substituent R⁵ is selected from the group consisting of:
C₁-C₆ alkyl;
C₂-C₆ alkynyl;
C₂-C₆ alkenyl;
C₃-C₆ cycloalkyl;
phenyl; and
C₅-C₇ heteroaryl.

3. The electrolyte according to claim 2, wherein R⁵ is C₂-C₄ alkyl.

4. The electrolyte according to claim 3, wherein R⁵ includes a 2-propyl, methyl, or ethyl group.

5. The electrolyte according to claim 2, wherein R⁵ is C₂-C₄ alkenyl.

6. The electrolyte according to claim 5, wherein R⁵ includes an ethenyl or propenyl group.

7. The electrolyte according to claim 2, wherein R⁵ is C₂-C₄ alkynyl.

8. The electrolyte according to claim 1, wherein at least a single atom or an atom group of the substituent R⁵ is substituted by a halogen atom or by a chemical group selected from the group consisting of C₁-C₄ alkyl, C₂-C₄ alkenyl, C₂-C₄ alkynyl, phenyl, benzyl and fully and partially halogenated C₁-C₄ alkyl, C₂-C₄ alkenyl, C₂-C₄ alkynyl, phenyl, and benzyl.

9. The electrolyte according to claim 8, wherein the substituent R⁵ is substituted by a halogen atom and the halogen atom is a fluorine atom.

10. The electrolyte according to claim 8, wherein the substituent R⁵ is substituted by the chemical group selected from the group consisting of fully and partially fluorinated C₁-C₄ alkyl, C₂-C₄ alkenyl, C₂-C₄ alkynyl, phenyl, benzyl and fully and partially halogenated C₁-C₄ alkyl, C₂-C₄ alkenyl, C₂-C₄ alkynyl, phenyl, and benzyl.

11. The electrolyte according to claim 1, wherein at least one atom group of the substituent R⁵ is a CF₃ group or an OSO₂CF₃ group.

12. The electrolyte according to claim 1, wherein the substituent R⁴ is a bidentate chelating ligand or is a polydentate chelating ligand.

13. The electrolyte according to claim 12, wherein the substituent R⁴ is a bidentate chelating ligand according to the formula —O—R⁵—O—.

14. The electrolyte according to claim 1, wherein the substituent R⁴ is a polydentate chelating ligand.

15. The electrolyte according to claim 1, wherein the first conducting salt is selected from the group consisting of:

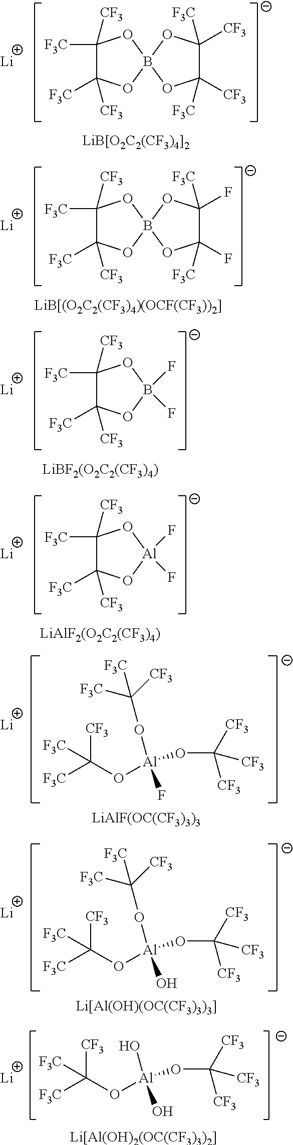

16. The electrolyte according to claim 1, further comprising a second conducting salt that differs from the first conducting salt of formula (I).

17. The electrolyte per claim 16, wherein the second conducting salt comprises formula (II) 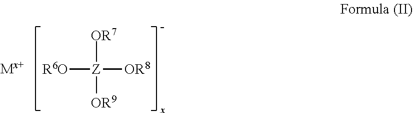
wherein,
m is a metal selected from the group consisting of alkali metals, alkali earth metals;
metals from Group 12 of the periodic table of elements and aluminum;
x is an integer from 1 to 3;
the substituents R⁶, R⁷, R⁸ and R⁹ are selected, independently of one another, from the group consisting of C₁-C₁₀ alkyl, C₂-C₁₀ alkenyl, C₃-C₁₀ cycloalkyl, C₆-C₁₄ aryl and C₅-C₁₄ heteroaryl; and
Z is aluminum or boron.

18. The electrolyte according to claim 16, wherein the second conductive salt of the electrolyte is an alkali metal compound.

19. The electrolyte according to claim 18, wherein the alkali metal compound is a lithium compound.

20. The electrolyte according to claim 19, wherein the lithium compound is selected from the group consisting of a lithium tetrahaloaluminate, a halide, an oxalate, a borate, a phosphate, an arsenate and a gallate.

21. The electrolyte according to claim 1, further comprising an additive.

22. The electrolyte according to claim 21, wherein the additive is selected from the group consisting of vinylene carbonate and the derivatives thereof, vinyl ethylene carbonate and the derivatives thereof, methyl ethylene carbonate and the derivatives thereof, lithium bis(oxolato)borate, lithium difluoro(oxalato)borate, lithium tetrafluoro(oxalato)phosphate, lithium oxalate, 2-vinylpyridine, 4-vinylpyridine, cyclic exomethylene carbonate, sultones, cyclic and acyclic sulfonates, acyclic sulfites, cyclic and acyclic sulfinates, organic esters, inorganic acids, acyclic and cyclic alkanes, which acyclic and cyclic alkanes have a boiling point at 1 bar of at least 36° C., aromatic compounds, halogenated cyclic and acyclic sulfonyl imides, halogenated cyclic and acyclic phosphate esters, halogenated cyclic and acyclic phosphines, halogenated cyclic and acyclic phosphites, halogenated cyclic and acyclic phosphazenes, halogenated cyclic and acyclic silylamines, halogenated cyclic and acyclic halogenated esters, halogenated cyclic and acyclic amides, halogenated cyclic and acyclic anhydrides and halogenated organic heterocyclic compounds.

23. The electrolyte according to claim 1, comprising the composition of:
(i) 5 to 99.4 wt. % sulfur dioxide;
(ii) 0.6 to 95 wt. % of the first conducting salt;
(iii) 0 to 25 wt. % of a second conducting salt; and
(iv) 0 to 10 wt. % of an additive;
based on the overall weight of the electrolyte composition.

24. The electrolyte according to claim 1, wherein the molar concentration of the first conducting salt is in a range selected from the group consisting of from 0.05 mol/l to 10 mol/l, from 0.1 mol/l to 6 mol/l, and from 0.2 mol/l to 3.5 mol/l, based on the overall volume of the electrolyte.

25. The electrolyte according to claim 1, wherein the electrolyte contains SO₂ in an amount selected from the group consisting of at least 0.1 mol of SO₂, at least 1 mol of SO₂, at least 5 mol of SO₂, at least 10 mol of SO₂ and at least 20 mol of SO₂ per mol of conducting salt.

26. A rechargeable battery cell, comprising:
the electrolyte according to claim 1;
an active metal;
a positive electrode;
a negative electrode; and
a housing.

27. The rechargeable battery cell according to claim 26, wherein the active metal is an alkali metal, an alkaline earth metal, or a metal from group 12 of the periodic table.

28. The rechargeable battery cell according to claim 27, wherein the active metal comprises lithium or sodium.

29. The rechargeable battery cell according to claim 27, wherein the active metal comprises calcium.

30. The rechargeable battery cell according to claim 27, wherein the active metal comprises zinc.

31. The rechargeable battery cell according to claim 26, wherein the negative electrode is an insertion electrode.

32. The rechargeable battery cell according to claim 31, wherein the insertion electrode comprises carbon as the active material.

33. The rechargeable battery cell according to claim 32, wherein the carbon comprises graphite.

34. The rechargeable battery cell according to claim 26, wherein the positive electrode comprises at least one intercalation compound as the active material.

35. The rechargeable battery cell according to claim 34, wherein the intercalation compound has the composition LiₓM′_{y}M″_{z}Oₐ, wherein:
M′ is at least one metal selected from the group consisting of the elements Ti, V, Cr, Mn, Fe, Co, Ni, Cu and Zn;
M″ is at least one element selected from the group consisting of the elements of 2, 3, 4, 5, 6, 7, 8, 9, 10, 11, 12, 13, 14, 15 and 16 of the periodic table of elements;
x and y are independently greater than 0;
z is greater or equal to 0; and
a is greater than 0.

36. The rechargeable battery cell according to claim 34, wherein the intercalation compound comprises the composition LiₓM′_{y}M″_{z}Oₐ, wherein M′ is iron and M″ is phosphorous.

37. The rechargeable battery cell according to claim 36, wherein x, y and z are equal to 1 and a is equal to 4.

38. The rechargeable battery cell according to claim 34, wherein the intercalation compound comprises the composition LiₓM′_{y}M″_{z}Oₐ, wherein M′ is manganese and M″ is cobalt.

39. The rechargeable battery cell according to claim 38, wherein x, y and z are equal to 1 and a is equal to 4.

40. The rechargeable battery cell according to claim 34, wherein the intercalation compound comprises the composition LiₓM′_{y}M″_{z}Oₐ, wherein M′ comprises nickel and manganese and M″ is cobalt.

41. The rechargeable battery cell according to claim 26, wherein the positive electrode contains a metal compound selected from the group consisting of a metal oxide, a metal halide and a metal phosphate.

42. The rechargeable battery cell according to claim 41, wherein the metal compound comprises a transition metal of atomic numbers 22 to 28 of the periodic table of the elements.

43. The rechargeable battery cell according to claim 42, wherein the metal compound comprises cobalt, nickel, manganese or iron.

44. The rechargeable battery cell according to claim 26, wherein the positive electrode and/or the negative electrode comprise a discharge element, which is either planar in the form of a metal plate or a metal foil, or three-dimensional in the form of a porous metal structure.

45. The rechargeable battery cell according to claim 44, wherein the discharge element is three-dimensional in the form of a porous metal structure and comprises a metal foam.

46. The rechargeable battery cell according to claim 26, wherein the positive electrode and/or the negative electrode comprises:
a fluorinated binder; or
a binder which consists of a polymer made from monomeric structural units of a conjugated carboxylic acid or from the alkali, alkali earth or ammonium salt of said conjugated carboxylic acid or a combination thereof; or
a binder which consists of a polymer that is based on monomeric styrene and butadiene structural units; or
a binder consisting of the group of carboxymethyl celluloses.

47. The rechargeable battery cell according to claim 46, wherein the positive electrode and/or the negative electrode comprises the fluorinated binder, the fluorinated binder comprising a polyvinylidene fluoride and/or a terpolymer consisting of tetrafluoroethylene, hexafluoropropylene and vinylidene fluoride.

48. The rechargeable battery cell according to claim 46, the binder is present in a concentration selected from the group consisting of no more than 20 wt. %, no more than 15 wt. %, no more than 10 wt. %, no more than 7 wt. %, no more than 5 wt. % and no more than 2 wt. %, based on the overall weight of the positive electrode or negative electrode.

49. The rechargeable battery cell according to claim 26, wherein the negative electrode comprises a plurality of negative electrodes and the positive electrode comprises a plurality of positive electrodes, the negative and the positive electrodes being arranged alternately in a stack in the housing.

50. The rechargeable battery cell according to claim 49, wherein the positive and negative electrodes in the stack are electrically separated from one another by separators.
